(19) United States
(12) Patent Application Publication
(10) Pub. No.: US 2008/0236347 A1
(43) Pub. Date: Oct. 2, 2008

(54) Swinging circular saw with lateral movement

(76) Inventor: Kenneth Jack Spencer, North Salt Lake, UT (US)

Correspondence Address: KARL R CANNON, PO BOX 1909, SANDY, UT, 84091, US

(21) Appl. No.: 11/899,408

(22) Filed: Sep. 4, 2007

Related U.S. Application Data
(63) Continuation of application No. 11/728,961, filed on Mar. 26, 2007.

(51) Int. Cl. B26D 1/18

(52) U.S. Cl. 83/13; 83/471.2

(57) ABSTRACT

A cutting device may include a base for supporting a material, such as wood, to be cut. A blade may be joined to an arm that swings about a pivot located above a cutting area. The blade may be allowed to move in a lateral direction through an arcuate path toward the user to cut the material. A biasing force may be applied to the arm to pull the arm to a retracted position off of the cutting area. A motor for driving the blade may be located on the arm above the blade such that the cutting area may remain visible to allow precise cutting. An abutment may be provided for aligning the material to be cut. A gap may be provided in the abutment to allow the blade to pass therethrough. Measuring indicia may be placed on opposing sides of the gap to facilitate measuring and cutting the material.

### CROSS-REFERENCE TO RELATED APPLICATIONS

This application is a continuation of co-pending U.S. patent application Ser. No. 11/728,961, filed Mar. 26, 2007, entitled SWINGING CIRCULAR SAW WITH LATERAL MOVEMENT which is hereby incorporated by reference herein in its entirety, including but not limited to those portions that specifically appear hereinafter, the incorporation by reference being made with the following exception: In the event that any portion of the above-referenced application is inconsistent with this application, this application supercedes said above-referenced application.

### STATEMENT REGARDING FEDERALLY SPONSORED RESEARCH OR DEVELOPMENT

Not Applicable.

### BACKGROUND

1. The Field of the Invention

The present disclosure relates generally to cutting devices, and more particularly, but not necessarily entirely, to a circular saw configured for providing lateral movement of a saw blade.

2. Description of Related Art

Circular saws are known in the art for cutting wood and other materials. The known circular saws may include a disc shaped saw blade with teeth on a perimeter of the blade. The circular saw may also include a motor for driving the blade, such that the blade is rotatable about an axis to allow cutting of material with the teeth on the blade perimeter. Some circular saws are portable, whereas other circular saws are provided as part of an attachment to a platform such as a table, bench or desk. Some of the known circular saws, such as table saws, are provided with a saw blade that may be positioned in a fixed location with respect to a table such that material to be cut is moved with respect to the saw blade for cutting the material. Other circular saws include saw blades that may be attached to a swinging arm that may move downwardly relative to the material to be cut. Such saws may sometimes be referred to as miter saws or chop saws. One drawback of such saws is that it may be difficult to precisely cut material since it may be difficult to determine exactly where the saw blade may contact the material as the saw blade is lowered from a raised position above the material. Still other circular saws may include saw blades that may be attached to a sliding carriage to allow, sliding of the saw blade in a lateral direction to cut the material.

Most of the known circular saws are designed to cut wood, however, the circular saws may be equipped with blades to cut masonry, plastics or metal. There are also circular saws specially designed for cutting any variety of materials.

Some of the known circular saws include a motor for driving the saw blade positioned such that viewing the material to be cut may sometimes be difficult. Other known circular saws are configured such that measuring and cutting material may be difficult to accomplish in a quick and safe manner.

The prior art is characterized by several disadvantages that are addressed by the present disclosure. The present disclosure minimizes, and in some aspects eliminates, the failures, and other problems of the prior art, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of a cutting device in accordance with the principles of the present disclosure;

FIG. 2 is a side view of an upper portion of the cutting device in a retracted position;

FIG. 3 is a side view of an upper portion of the cutting device in a cutting position;

FIG. 4 is a front view of an upper portion of the cutting device;

FIG. 5 is a break-away perspective view of an interior portion of the cutting device;

FIG. 6 is a break-away view of a lower portion of the cutting device; and

FIG. 7 is a view of one embodiment of a dust collector useful with the cutting device.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present cutting device is disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

It must be noted that, as used in this specification and the appended claims, the singular forms “a,” “an,” and “the” include plural referents unless the context clearly dictates otherwise. Also, as used herein, the terms “comprising,” “including,” “containing,” “characterized by,” and grammatical equivalents thereof are inclusive or open-ended terms that do not exclude additional, unrecited elements or method steps.

As used herein, the term “lateral” movement shall refer broadly to the concept of movement generally toward a side, as opposed to movement generally in the upward or downward direction. For example, arcuate movement that is generally side to side (or front to back) may be considered to be lateral movement even though a component of the movement is in the upward or downward direction, as long as the sidewards movement dominates. Accordingly, lateral movement of a blade would allow the blade to contact a side of a piece of material to be cut.

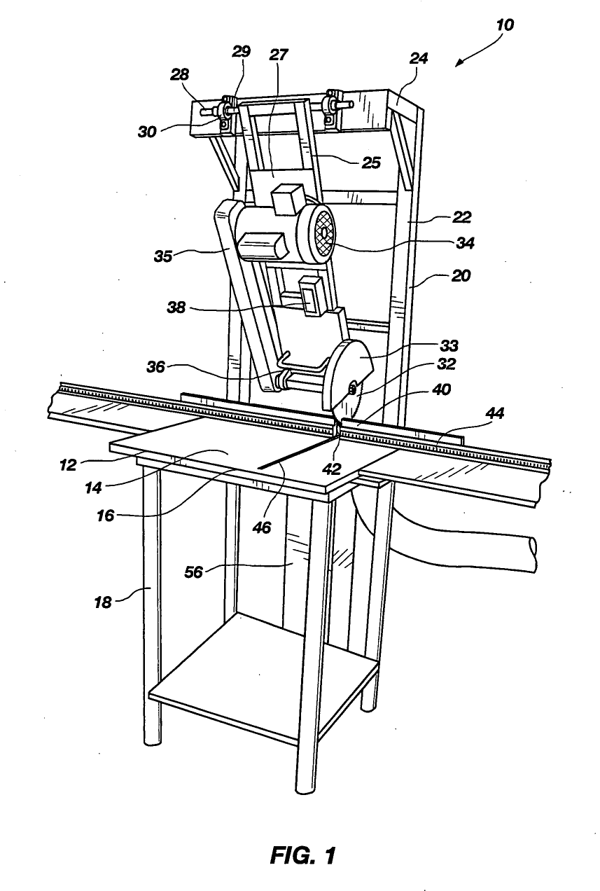

Referring now to FIG. 1, a perspective view of a cutting device is shown, indicated generally at 10. The cutting device 10 may include a base 12 for supporting material to be cut. The base 12 may be formed in various different shapes, sizes and configurations, such as a table, desk or bench for example. The base 12 may include a surface 14 defined by an edge or perimeter 16 for receiving and supporting material such as wood to be cut. It will be understood that the cutting device 10 of the present disclosure may be utilized to cut various different types of materials, such as wood, plastics, masonry, metal, or synthetic materials, for example. The base 12 may also include a plurality of legs 18 for supporting the surface 14 in an elevated position. It will be understood that the surface 14 may be supported in a cantilever arrangement with the base 12 fixed to a structural wall, or the surface 14 may be supported by a solid structure or pedestal, or the surface may be supported by wall members such as those forming a cabinet, for example, or any other arrangement known in the art. It will also be understood that some embodiments of the present disclosure may be provided without legs 18 or various different portions of the base 12 such that the cutting device 10 may be portable for use on various different support surfaces.

The cutting device 10 may also include a support 20 disposed on the base 12. One embodiment of the support 20 may be fixedly attached to the base 12, whereas other embodiments may be removably attachable to the base 12. The support 20 may include an upright portion 22 and a lateral extending portion 24. The support may be formed of a single piece member or multiple pieces joined together, such as by welding, for example. It will be understood that the support 20 may be formed in various different configurations and may have various different brace structures within the scope of the present disclosure. For example, the support 20 may be formed in a frame or truss arrangement formed substantially in the shape of an inverted “L”. An alternative embodiment of the present disclosure may include a support that may be formed as a cantilever extending from a structural wall, or as an integral part of a structural wall. Still other embodiments may be configured to be joined to a ceiling.

An arm 26 may be joined with the support 20 on the lateral extending portion 24 through a pivot 28. In one embodiment of the present disclosure, the pivot 28 may include a rod 29 that may be rotatably attached to the support 20. It will be understood that the pivot 28 may include any variety of moveable connection known in the art such as a hinge connection, universal connection, or ball and socket connection, for example. In one embodiment of the present disclosure, the pivot 28 may be fixed to the support 28 through one or more stationary journals 30 that allow movement of the rod 29 with respect to the journals 30 and the support 20. Other embodiments of the present disclosure may include a pivot 28 that may have an adjustable position. For example, the journals 30 may be disposed on threaded rods or any other known mechanism for adjusting the position of the journals 30 with respect to the support 20. Accordingly, in one embodiment of the present disclosure, the location where the arm 26 connects with the support 20 may be fixed, whereas in other embodiments, the location where the arm 26 connects with the support 20 may be adjustable.

Other alternative embodiments of the present disclosure may include adjustable supports that allow adjustable positioning of the arm 26. For example, the upright portion 22 or lateral portion 24 of the support 20 may be formed of telescoping members that may be adjusted in length. Any variety of fastening mechanisms known in the art, such as threaded couplers or detent mechanisms, for example, may be utilized to hold the adjustable support in a desired position.

It will be understood that one embodiment of the present disclosure may include the pivot 28 positioned above the cutting surface 14 such that the arm 26 may be laterally movable through the cutting area. For example, one embodiment of the cutting device 10 may include the pivot 28 positioned vertically above the cutting surface 14 such that when the arm 26 is positioned vertically, the blade 32 may be positioned within the perimeter 16 of the cutting surface 14. Moreover, the device 10 may be configured such that the arm 26 may swing about the pivot 28 such that the blade 32 is positioned outside the perimeter 16 of the cutting surface 14, as viewed from above, when the arm 26 is in a retracted position and the blade 32 is positioned within the perimeter 16 when the blade 32 is in a cutting position. Other embodiments of the device 10 may include the pivot 28 above the cutting surface 14 in a non-vertical relationship that may allow lateral movement of the blade 32 through the cutting surface 14.

The arm 26 may be formed of a single member or multiple members that may be joined together. For example, the arm 26 may include a pair of upright members 25, having a length configured for extending in a primarily upward and downward direction. The upright members 25 may be spaced apart and joined together by one or more lateral members 27. An alternative embodiment of the arm may include a single elongate member extending from the pivot 28.

A blade 32 may be joined with the arm 26 on an end portion of the arm opposite the pivot 28. The blade 32 may be formed as a circular saw blade having teeth on a perimeter in a manner known to those skilled in the art. The blade 32 may be formed of a material and have teeth suitable for cutting a particular material. One alternative embodiment of the blade 32 may be formed with a sharp edge on the perimeter of the blade without any teeth. It will be understood that the thickness and diameter of the blade 32 may vary within the scope of the present disclosure.

A guard 33 may be positioned around a portion of the blade 32 to provide protection against contact with the blade 32 except where desired to cut the material. The guard 33 may be formed as a protective cover configured in any manner known in the art for receiving the blade 32 therein and preventing access to a portion of the blade 32. It also will be understood that some embodiments of the present disclosure may be formed without a guard 33.

One embodiment of the present disclosure may include a motor 34 disposed on the arm 26 at a position between the pivot 28 and the blade 32. The motor 34 may be any suitable motor known in the art, such as an electric motor, for driving the blade 32. For example, one embodiment of the present disclosure may include a motor 34 for providing a rotational output to a drive shaft and drive mechanism. The drive shaft may drive a belt which may in turn cause a shaft joined to the blade 32 to rotate, thereby rotating the blade 32. It will be understood however, that any variety of drive mechanism known to those skilled in the art may be utilized to drive the blade 32 within the scope of the present disclosure. Also, an electrical cord may be joined with the motor 34 leading to an electrical outlet in any manner known to those skilled in the art, or alternative embodiments of the motor 34 may be battery operated.

A protective cover 35 may be provided to provide a safety feature to prevent people or objects from coming into contact with the drive mechanism. One embodiment of the cover 35 may be removable to facilitate maintenance on the drive mechanism. The cover 35 may also at least partially conceal the drive mechanism to improve the appearance of the device 10 and reduce the amount of dust or debris which may contact the drive mechanism.

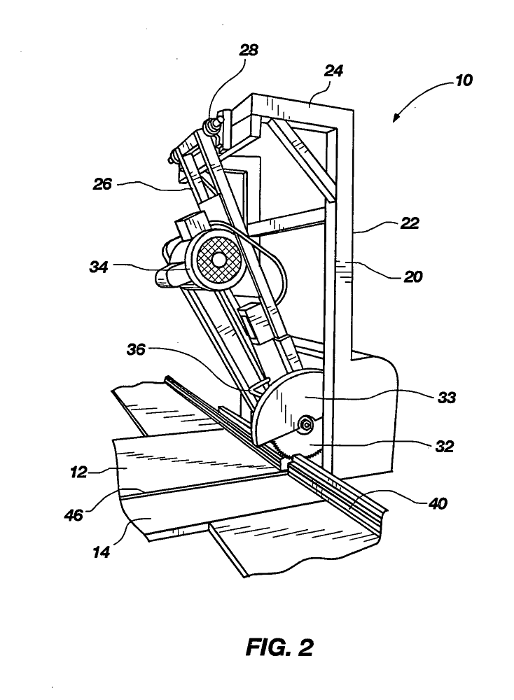

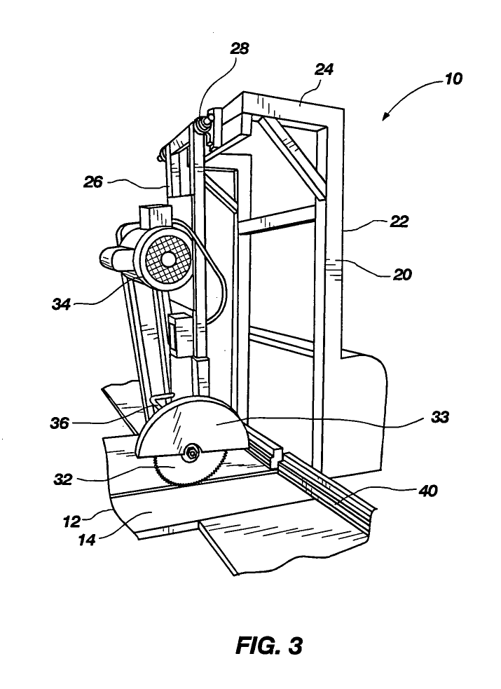

One embodiment of the present disclosure may include a motor 34 that may be positioned on the arm 36 such that when the arm 36 is in a retracted position, as shown most clearly in the side view of the device 10 of FIG. 2, a center of gravity of the motor 34 may be positioned on an interior side of the pivot 28. In other words, the center of gravity of the motor 34 may be positioned on a side of the pivot 28 towards the upright portion 22 of the support 20. This configuration may utilize the weight of the motor 34 to facilitate rotation of the arm 26 toward the cutting position, as shown most clearly in FIG. 3.

It will be understood that other embodiments of the present disclosure may include the motor 34 positioned on the arm 26 such that the center of gravity of the motor 34 may be positioned on the exterior side of the pivot 28 when the arm 26 is positioned in the retracted position. This arrangement may utilize the weight of the motor 34 to bias the arm toward the retracted position. It will also be understood that other embodiments of the present disclosure may include the motor 34 located at other positions, such as where the center of gravity of the motor 34 is directly beneath the pivot 28 when the arm 26 is positioned in the retracted position. Moreover, the motor 34 may be adjustably mounted to the arm 26 such that the motor 34 may be adjustably positioned at any suitable location along the length of the arm 26. Also, the motor 34 may be disposed on other portions of the device 10, such as on the lateral portion 24 of the support 20, within the scope of the present disclosure.

One embodiment of the device 10 may include the motor 34 positioned on the arm 26 at a location within a range of approximately 0.3 to 0.7 of the length of the arm 26 from the pivot 28. More specifically, one embodiment of the present disclosure may include the motor 34 positioned on the arm 26 at a location within a range of approximately 0.4 to 0.6 of the length of the arm 26 from the pivot 28. However, as previously discussed, the motor 34 may be positioned at other positions along the length of the arm 26, such as near the pivot 28, or near the blade 32 in alternative embodiments of the present disclosure.

A handle 36 may be positioned on the arm 26 to facilitate grasping the arm 26 to pull the arm 26 from the retracted position toward the cutting position. The handle 36 may be formed as a substantial “U” shaped member or in any other suitable configuration known to those skilled in the art. A switch 38 may also be provided on the arm 26 for turning on the motor 34 to operate the cutting device 10. It will be appreciated that the switch 28 may be provided in various different locations within the scope of the present disclosure. It will also be understood that the switch 28, or other such switches, may be utilized to operate other features, such as dust collection devices or lights, for example.

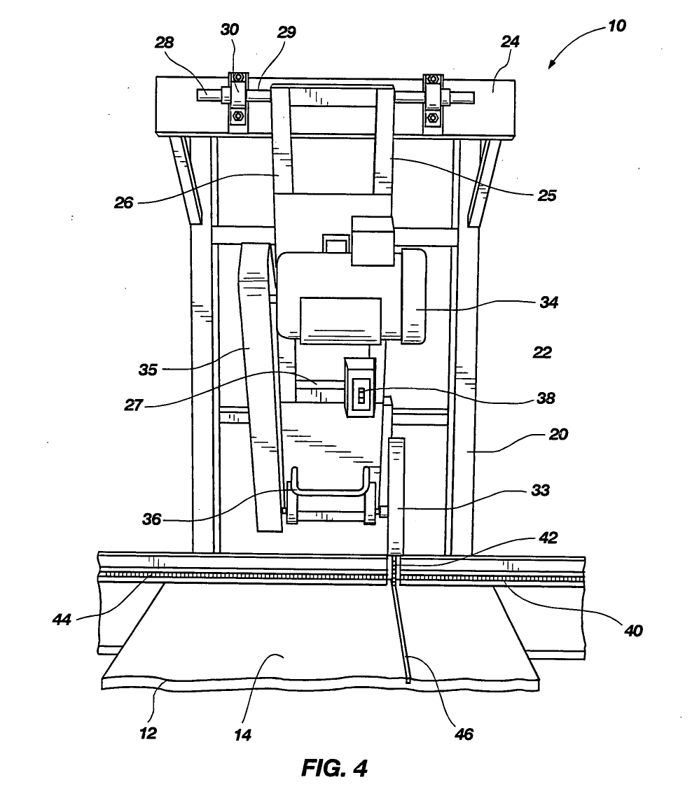

Referring now to FIG. 4, a front view of a portion of the cutting device 10 is shown. An abutment 40 may be provided on the surface 14. The abutment 40 may be in the form of a ridge, projection or a wall, for example, fixedly or removably attached to the surface for allowing wood or other such material to be aligned as desired for cutting. The abutment 40 may include a gap 42 for allowing the blade 32 to pass therethrough as the blade 32 moves from the retracted position to the cutting position. Measuring indicia 44 may be disposed on the abutment 40 on opposing sides of the gap 42. It will be understood that the measuring indicia 44 may include length markings in any suitable units to facilitate measuring lengths of material to be cut. For example, if it is desired to cut a piece of wood at a particular length, the wood may be placed against the abutment 40 and moved to the desired length as measured by the measuring indicia 44. It will be understood that one embodiment of the present disclosure may include the measuring indicia 44 on the abutment 40 on both sides of the gap 42 such that material to be cut may be measured from either direction. Accordingly, the length of the material to be cut, and the length of the material remaining may be easily determined such that the time required for cutting the material may be reduced.

One embodiment of the cutting device 10 may include a slot 46 in the surface 14 for allowing the blade 32 to pass therethrough as the arm is rotated to the cutting position. Accordingly, one embodiment of the present disclosure may include the arm 26 configured to swing about the pivot 28 such that the blade 32 may be laterally moveable through the slot 46 in an arcuate path. The slot 46 may have a width that is sufficient to allow passage of the blade 32 without contacting a side of the slot 46. One embodiment of the slot 46 may be configured such that the slot 46 passes completely through the member forming the surface 14 such that the slot 46 may be configured without a bottom. However, other embodiments of the slot 46 may be formed in the shape of a channel with a bottom. Braces may be provided beneath the member forming the surface 14 on opposing sides of the slot 46 such that the surface 14 may be stable even if the surface is loaded from above with material to be cut.

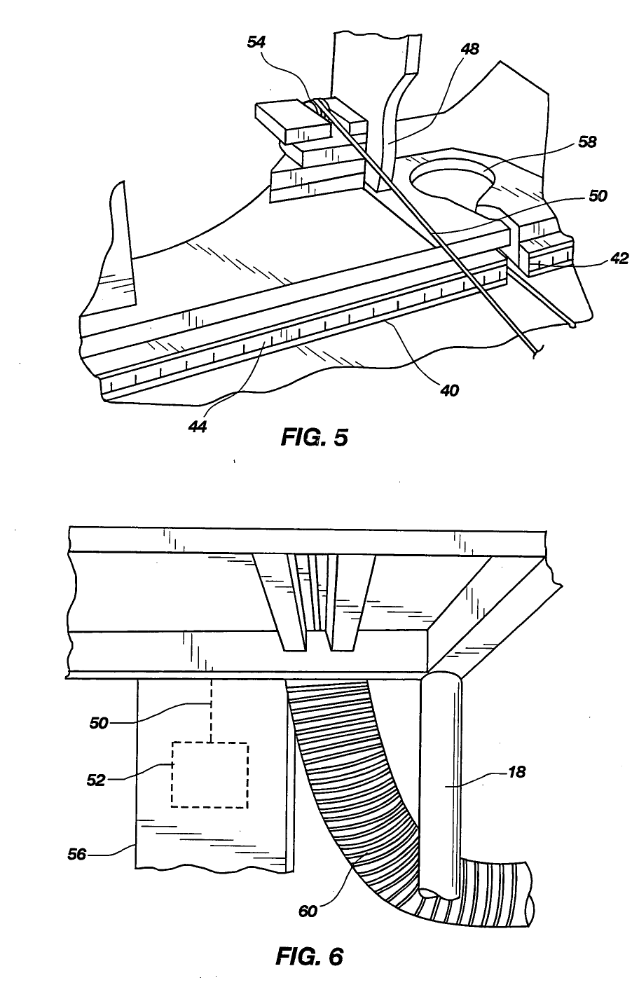

Referring now to FIG. 5, a break-away portion of the cutting device 10 is shown with the arm 26 out of view in the cutting position. One embodiment of the present disclosure may include a stop 48 for contacting the arm 26 to limit the movement of the arm 26 in the retracted position direction. It will be understood that one embodiment of the stop 48 may be formed as a resilient bumper so as to cushion the impact of the arm 26 with the stop 48. Other embodiments of the stop 48 may be formed of other materials, such as wood or metal for example. It will also be understood that another embodiment of the present disclosure may include a stop configured in any manner known in the art for preventing movement of the arm 26 in a direction toward the user to prevent the arm 26 from extending too close to the user.

As shown in FIG. 2, a space 49 may be provided between the arm 26 and the lateral portion 24 of the support 20 when the arm is in the retracted position such that the arm 26 may not contact the support 20 except through the pivot 28 and the stop 48. Still other embodiments of the device 10 may be formed without a stop 48, or the arm 26 may contact portions of the support 20 to limit movement of the arm 26. It will be understood that the stop 48 may be formed in various different sizes, shapes, locations and configurations within the scope of the present disclosure.

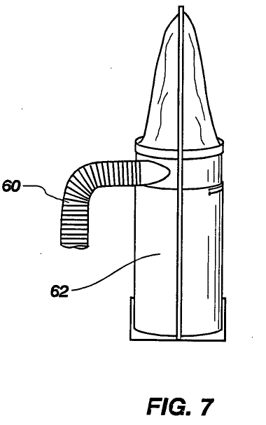

One embodiment of the cutting device 10 may include a biasing means for biasing the arm 26 toward the retracted position. Accordingly, if the arm 26 is released by the user, the arm 26 may automatically move away from the user and off of the cutting surface 14. This may enhance the safety of the cutting device 10 and facilitate operation of the device 10. The biasing means may include a cord 50 attached to the arm 26 at one end, and a weight 52, as shown in dashed lines in FIG. 6, attached to the cord 50 at the other end. A pulley 54 may be joined to the base 12 to facilitate movement of the cord 50 and make movement of the cord 50 smooth. It will be understood that the weight 52 may create a force to pull on the arm 26 to thereby bias the arm 26 toward the retracted position. It will also be understood that the biasing force may be altered by adding or decreasing the amount of weight joined to the cord 50. A housing 56 may be provided for receiving the weight 52 to provide a clear space for movement of the weight 52 and to protect the weight from coming into contact with objects as the weight 52 is moved.

It will be understood that other embodiments of the present disclosure may include a biasing means in the form of one or more springs or other resilient members attached to the arm 26 and the support 20. Moreover, other embodiments may not include a biasing means and some embodiments may include only a biasing force created by the weight of the motor 34.

Another feature of the present disclosure may include a dust collection system. An opening 58 may be provided on the base 12 for receiving dust and other debris therein. It will be understood that the location, size and shape of the opening 58 may vary to provide the desired intake capabilities of dust. One embodiment of the opening may be provided beneath the blade 32 when the blade 32 is in the retracted position. A conduit 60, such as a flexible pipe, may connect the opening 58 with a suction device 62, as shown in FIG. 7. It will be understood that as the cutting device 10 is operated, the suction device may be activated to draw sawdust or other debris through the opening 58 and conduit 60 into a containment area. Thus, the cutting surface 14 may be maintained free of sawdust to facilitate cleaning and working on the cutting surface 14. Moreover, the amount of dust in the air may be reduced thereby making the work environment more healthy. It will be understood that the suction device 62 may be formed in any manner known to those skilled in the art and may sometimes be referred to as a blower. It will also be understood that other embodiments of the present disclosure may include an opening along the slot 46 connected to the conduit 60, or that the conduit 60 may be joined to the guard 33 and the conduit 60 may extend along the arm 26, such that other arrangements of the dust collection system are considered to fall within the scope of the present disclosure.

One embodiment of the present disclosure may include a base 12 having a cutting surface 14 dimensioned within a range of approximately two to four feet in length by approximately one to three feet in width. The cutting surface 14 may be substantially smooth and planar. Extensions may be joined to the cutting surface 14 to extend the length of the cutting surface 14 to any desired length which may be beneficial in assisting in cutting material having longer dimensions. The height of the surface 14 may be configured to allow a user to comfortably access and work on the surface 14 while standing, for example.

One embodiment of the arm 26 may include first and second upright members 25. The motor 34 may be configured in a substantially cylindrical configuration extending between the first and second upright members 25. The arm 26 may have a length of between two to five feet, for example, to provide desired lateral movement capabilities. It will be understood that arms of various different lengths may be used within the scope of the present disclosure.

Operation of the cutting device 10 will now be described. A piece of material to be cut may be placed on the cutting surface 14 and moved against the abutment 40 to align the material with the abutment 40 such that the material may be cut at the desired angle. It will be understood that one embodiment of the cutting surface 14 and abutment 40 may be fixed such that the material may be cut at a ninety degree angle with respect to the abutment 40. Other embodiments of the cutting surface 14 may be adjustable such that the cutting surface 14 and abutment 40 may be rotated in a substantially horizontal plane to allow cutting of material at other angles besides angles perpendicular with the abutment 40.

Once the material to be cut is aligned with the abutment 40, the material may be measured with the measuring indicia 44 to determine the proper location to cut the material. The material may be marked if desired, or the material may be visually located with respect to the measuring indicia 44 to achieve a cut in the desired location. The switch 38 may be activated to turn on the motor 34 to thereby start rotation of the blade 32. The switch 38 may also activate the suction device 62, or another switch may be used to activate the suction device 62 such that sawdust or debris generated by cutting the material may be automatically removed from the cutting surface 14. The user may then grasp the handle 36 and pull the arm 26 toward the user such that the blade 32 may be drawn into a lateral side of the material to be cut. It will be understood that since the motor 32 may be positioned on the arm 26 above the blade 32, the user may have clear visual access to the blade 32 and the material to be cut. Since the blade 32 is moving in a lateral direction toward the user, the user can also easily visually align the blade with the material to be cut. Once the blade 32 is pulled through the material and the material is cut as desired, the pulling force applied by the user to the handle may be reduced to allow the arm 26 to move back toward the retracted position. It will be understood that the force of the weight 52 through the cord 50 may bias the arm 26 to automatically move the arm 26 back to the retracted position such that the blade 32 may be removed from the cutting surface 14 in a safe location. The material to be cut may then be readjusted for a subsequent cut, if necessary, in a rapid manner such that the time required to align and cut the material may be reduced.

It will be understood that the cutting device 10 may be used to cut materials having different thicknesses. In some instances, it may be beneficial to place a spacer, such as a piece of wood, between the abutment 40 and the material to be cut, so that the material to be cut may be positioned further away from the abutment 40. This procedure may allow thicker pieces of material to be cut in situations where the thickness of the material to be cut causes the material to contact the blade 32 to thereby prevent the material from contacting the abutment 40. Other embodiments may allow the blade 32 to be moved far enough off of the cutting surface 14 in the retracted position such that the blade 32 may not contact the material to be cut regardless of the material thickness. Still other embodiments may include an adjustable arm or supports that allows material of various thicknesses to be cut.

One aspect of the present cutting device 10 is that the blade 32 may be positioned such that it may be easily accessed for repair or replacement. Similarly, the motor 34 and the drive mechanism beneath the cover 35 may also be easily accessed such that accomplishing maintenance tasks on the cutting device 10 may be facilitated. It will also be understood that the present cutting device 10 may be easily aligned, and the alignment may be maintained such that misaligned cuts in the material are more easily avoided.

The components of the present disclosure may be manufactured in a manner known to those skilled in the art using any suitable materials capable of providing proper strength and durability characteristics. For example, the support 20 and arm 26 may be formed of a suitable metal material.

It will be understood that an alternative embodiment of the present disclosure may be provided in which the retracted position is configured to be next to the user, and the user may push the arm 26 in a direction away from the user to cut the material. Accordingly, it will be understood that the support 20 may be positioned on one or both of the near and far sides of the cutting surface 14 with respect to the user. Similarly, the abutment 40 may be positioned such that the blade 32 may pass through the gap 42 as the blade 32 finishes the cut in the material rather than before the blade 32 contacts the material. It will also be understood that the cutting device 10 may be arranged such that a user may rotate the arm 26 in a side to side direction with respect to the user, rather than in a direction towards and away from the user. Moreover, another alternative embodiment of the present disclosure may be provided in which the arm 26 may be configured to move in a linear movement path rather than through an arcuate path. For example, the arm 26 may be disposed on a carriage or one or more rails which allow movement of the arm in a linear direction. Accordingly, the arm 26 may be allowed to move in a lateral direction without movement in an upward or downward direction.

It will be appreciated that the structure and apparatus disclosed herein is merely one example of a means for moving a blade laterally through a material in an arcuate path, and it should be appreciated that any structure, apparatus or system for moving a blade laterally through a material in an arcuate path which performs functions the same as, or equivalent to, those disclosed herein are intended to fall within the scope of a means for moving a blade laterally through a material in an arcuate path, including those structures, apparatus or systems for moving a blade laterally through a material in an arcuate path which are presently known, or which may become available in the future. Anything which functions the same as, or equivalently to, a means for moving a blade laterally through a material in an arcuate path falls within the scope of this element.

It will be appreciated that the structure and apparatus disclosed herein is merely one example of a means for collecting dust, and it should be appreciated that any structure, apparatus or system for collecting dust which performs functions the same as, or equivalent to, those disclosed herein are intended to fall within the scope of a means for collecting dust, including those structures, apparatus or systems for collecting dust which are presently known, or which may become available in the future. Anything which functions the same as, or equivalently to, a means for collecting dust falls within the scope of this element.

In accordance with the features and combinations described above, a useful method of cutting a material includes the steps of:

placing the material on a surface between a user and a blade; and

moving the blade through the material and the surface in an arcuate path toward the user.

In accordance with the features and combinations described above, another useful method of cutting a material may include the steps of:

placing the material on a surface between a user and a blade;

positioning the material against an abutment, the abutment having a gap;

moving the blade through the gap in an arcuate path toward the user.

Those having ordinary skill in the relevant art will appreciate the advantages provide by the features of the present disclosure. For example, it is a feature of the present disclosure to provide a cutting device that is simple in design and manufacture. Another feature of the present disclosure is to provide such a cutting device that is simple to operate such that the time required to cut materials may be reduced. It is a further feature of the present disclosure, in accordance with one aspect thereof, to provide a cutting device that allows materials to be cut in a precise manner by allowing lateral movement of a saw blade which can allow the blade to be visually aligned with markings on the material to be cut. It is a further feature of the present disclosure to provide a cutting device that is configured to allow the material to be visible without being obstructed by the motor driving the saw blade. It is an additional feature of the present disclosure to provide a cutting device that can be operated with a dust collection system to remove sawdust or other debris from the cutting area. It is another feature of the present disclosure to provide a cutting device that is safe to operate. It is an additional feature of the present disclosure to provide a cutting device that allows the saw blade to move in a lateral direction through an arcuate path by rotating the saw blade about a pivot located above the cutting area. It is an additional feature of the present disclosure to provide a biasing mechanism to automatically move the blade to a retracted position off of the cutting area.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A device for cutting material, said device comprising:
a base configured for supporting said material, said base comprising a slot;
a pivot disposed on a support, said pivot positioned above said base;
an-arm rotatably attached to said pivot; and
a blade disposed on said arm;
wherein said arm is configured to swing about said pivot such that said blade is laterally moveable through said slot.

2. The device of claim 1, wherein said arm is movable between a retracted position and a cutting position, and wherein said device further comprises a weight joined to said arm for biasing said.

3. The device of claim 1, wherein said base comprises an abutment for being contacted by said material to orient said material, said abutment comprising a gap for allowing said blade to pass therethrough.

4. The device of claim 3, further comprising measuring indicia disposed on said abutment on opposing sides of said gap to facilitate cutting said material at specified dimensions.

5. The device of claim 1, further comprising a motor disposed on said arm for driving said blade.

6. The device of claim 1, wherein said base comprises a perimeter defining a surface for supporting said material.

7. The device of claim 6, wherein said arm swings about said pivot such that said blade is positioned outside said perimeter of said surface when said arm is in a retracted position and said blade is positioned within said perimeter when said blade is in a cutting position.

8. The device of claim 6, wherein said pivot is positioned vertically above said surface.

9. The device of claim 1, further comprising means for collecting dust generated while cutting said material.

10. The device of claim 1, further comprising a stop for limiting the movement of said arm in a retracted position.

11. The device of claim 1, wherein said support comprises an upright portion and a lateral portion.

12. The device of claim 11, wherein said pivot is disposed on said lateral portion;

13. The device of claim 1, further comprising one or more legs for supporting said base in an elevated position.

14. The device of claim 1, wherein said arm is movable between a retracted position and a cutting position, and wherein said device further comprises a weight joined to said arm for biasing said arm to said-retracted position, said weight being attached to a cord and said cord being attached to said arm, and wherein said cord passes over a pulley between said arm and said weight;
wherein said device further comprises a housing for receiving said weight;
wherein said base comprises an abutment for being contacted by said material to orient said material, said abutment comprising a gap for allowing said blade to pass therethrough;
wherein measuring indicia are disposed on said abutment on opposing sides of said gap to facilitate cutting said material at specified dimensions;
wherein said devices further comprises a motor disposed on said arm for driving said blade, said motor being positioned between said pivot and said blade;
wherein said motor is positioned on said arm a distance ranging from 0.4 to 0.6 of the length of the arm from said pivot;
wherein said motor is positioned on said arm such that a center of gravity of said motor is positioned on a side of said pivot closest to said support when said arm is in said retracted position;
wherein said base comprises a perimeter defining a surface for supporting said material;
wherein said arm swings about said pivot such that said blade is positioned outside said perimeter of said surface when said arm is in said retracted position and said blade is positioned within said perimeter when said blade is in said cutting position;
wherein said pivot is positioned vertically above said surface;
wherein said device further comprises means for collecting dust generated while cutting said material, said means for collecting dust comprising an opening in said base and a conduit leading from said opening to a suction device;
wherein said device further comprises a stop for limiting the movement of said arm in said retracted position;
wherein said support comprises an upright portion and a lateral portion;
wherein said pivot is disposed on said lateral portion of said support;
wherein a space is provided between said arm and said lateral portion of said support when said arm is in said retracted position;
wherein said device further comprises one or more legs for supporting said-base in an elevated position;
wherein said device further comprises a handle on said arm for pulling said arm towards a user.

15. A device for cutting material, said device comprising:
a base configured for supporting said material;
a pivot disposed on a support;
an arm rotatably attached to said pivot such that said arm is movable from a retracted position to a cutting position;
a blade disposed on said arm; and
a weight joined to said arm for biasing said.

16. The device of claim 15, wherein said weight is joined to a cord and said cord is joined to said arm.

17. The device of claim 16, wherein a pulley is positioned on said cord between said arm and said weight.

18. The device of claim 15, further comprising a housing for receiving said weight.

19. The device of claim 15, wherein said base comprises a slot, and wherein said arm is configured to swing about said pivot such that said blade is laterally moveable through said slot in an arcuate path.

20. The device of claim 15, wherein said base comprises an abutment for being contacted by said material to orient said material, said abutment comprising a gap for allowing said blade to pass therethrough.

21. The device of claim 20, further comprising measuring indicia disposed on said abutment on opposing sides of said gap to facilitate cutting said material at specified dimensions.

22. The device of claim 15, further comprising a motor disposed on said arm for driving said blade.

23. The device of claim 15, further comprising means for collecting dust generated while cutting said material.

24. A device for cutting material, said device comprising:
a base configured for supporting said material, said base comprising an abutment for being contacted by said material to orient said material, said abutment comprising a gap; and
a blade configured for passing through said gap to cut said material;
wherein measuring indicia are disposed on said abutment on opposing sides of said gap to facilitate cutting said material at specified dimensions.

25. The device of claim 24, further comprising a pivot disposed on a support, said pivot being positioned above said base.

26. The device of claim 25, further comprising an arm rotatably attached to said pivot.

27. The device of claim 26, wherein said base comprises a slot, and wherein said arm is configured to swing about said pivot such that said blade is laterally moveable through said slot.

28. The device of claim 26, further comprising a motor disposed on said arm for driving said blade.

29. The device of claim 25, wherein said base comprises a surface for supporting said material when said material is being cut, wherein said pivot is positioned above said surface.

30. The device of claim 24, further comprising means for collecting dust generated while cutting said material.

31. A device for cutting material, said device comprising:
a base configured for supporting said material;
a pivot disposed on a support, said pivot positioned above said base;
an arm rotatably attached to said pivot;
a blade disposed on said arm; and
a motor disposed on said arm for driving said blade;
wherein said arm is configured to swing about said pivot such that said blade is laterally moveable through said material.

32. The device of claim 31, wherein said motor is positioned on said arm a distance ranging from 0.3 to 0.7 of the length of the arm from said pivot.

33. The device of claim 32, wherein said motor is positioned on said arm a distance ranging from 0.4 to 0.6 of the length of the arm from said pivot.

34. The device of claim 31, wherein said motor is positioned on said arm such that a center of gravity of said motor is positioned on a side of said pivot closest to said support when said arm is in a retracted position.

35. The device of claim 31, wherein said base comprises a slot for receiving said blade.

36. The device of claim 31, wherein said arm is movable between a retracted position and a cutting position, and further comprising a weight joined to said arm for biasing said arm.

37. The device of claim 31, wherein said base comprises an abutment for being contacted by said material to orient said material, said abutment comprising a gap for allowing said blade to pass therethrough.

38. The device of claim 37, further comprising measuring indicia disposed on said abutment on opposing sides of said gap to facilitate cutting said material at specified dimensions.

39. The device of claim 31, further comprising means for collecting dust generated while cutting said material.

40. A device for cutting material, said device comprising:
a base comprising a perimeter defining a surface for supporting said material;
a pivot disposed on a support;
an arm rotatably attached to said pivot such that said arm is movable from a retracted position to a cutting position; and
a blade disposed on said arm;
wherein said arm swings about said pivot such that said blade is positioned outside said perimeter of said surface when said arm is in said retracted position and said blade is positioned within said perimeter when said blade is in said cutting position.

41. The device of claim 40, wherein said base comprises a slot for receiving said blade.

42. The device of claim 40, further comprising a weight joined to said arm for biasing said arm to said retracted position.

43. The device of claim 40, wherein said base comprises an abutment for being contacted by said material to orient said material, said abutment comprising a gap for allowing said blade to pass therethrough.

44. The device of claim 43, further comprising measuring indicia disposed on said abutment on opposing sides of said gap to facilitate cutting said material at specified dimensions.

45. The device of claim 40, further comprising a motor disposed on said arm for driving said blade.

46. The device of claim 40, wherein said pivot is positioned vertically above said surface.

47. The device of claim 40, further comprising means for collecting dust generated while cutting said material.

48. A device for cutting material, said device comprising:
a base configured for supporting said material;
a pivot disposed on a support, said pivot positioned above said base;
an arm rotatably attached to said pivot;
a blade disposed on said arm; and
means for collecting dust generated while cutting said material;
wherein said arm is configured to swing about said pivot such that said blade is laterally moveable through said material.

49. The device of claim 48, wherein said means for collecting dust comprises an opening in said base.

50. The device of claim 49, wherein said opening is disposed under said blade when said blade is in a retracted position.

51. The device of claim 49, wherein said means for collecting dust comprises a conduit joined with said opening.

52. The device of claim 48, wherein said means for collecting dust comprises a suction device.

53. The device of claim 48, wherein said base comprises a slot, and wherein said arm is configured to swing about said pivot such that said blade is laterally moveable through said.

54. The device of claim 48, wherein said base comprises an abutment for being contacted by said material to orient said material, said abutment comprising a gap for allowing said blade to pass therethrough.

55. The device of claim 54, further comprising measuring indicia disposed on said abutment on opposing sides of said gap to facilitate cutting said material at specified dimensions.

56. The device of claim 48, further comprising a motor disposed on said arm for driving said blade.

57. A device for cutting material, said device comprising:
a base configured for supporting said material;
a blade for cutting said material; and
means for moving said blade laterally through said.

58. The device of claim 57, wherein said means for moving said blade comprises a support joined to said base.

59. The device of claim 58, wherein said support comprises an upright portion and a lateral portion.

60. The device of claim 59, wherein said means for moving said blade comprises a pivot joined to said lateral portion.

61. The device of claim 57, wherein said means for moving said blade comprises a pivot.

62. The device of claim 61, wherein said means for moving said blade comprises an arm joined to said pivot.

63. The device of claim 61, wherein said pivot is positioned vertically above a surface for supporting said material to be cut.

64. The device of claim 57, wherein said base comprises a slot for receiving said blade.

65. The device of claim 57, wherein said base comprises an abutment for being contacted by said material to orient said material, said abutment comprising a gap for allowing said blade to pass therethrough.

66. The device of claim 65, further comprising measuring indicia disposed on said abutment on opposing sides of said gap to facilitate cutting said material at specified dimensions.

67. The device of claim 57, further comprising a motor disposed on said means for moving said blade.

68. The device of claim 57, further comprising means for collecting dust generated while cutting said material.

69. A method of cutting a material, said method comprising:
placing said material on a surface between a user and a blade; and
moving said blade through said material and said surface toward said user.

70. The method of claim 69, further comprising placing said material against an abutment on said surface.

71. The method of claim 70, further comprising measuring said material using measuring indicia on said abutment.

72. The method of claim 70, further comprising moving said blade through a gap in said abutment.

73. The method of claim 70, further comprising placing a spacer between said material and said abutment.

74. The method of claim 69, further comprising biasing said blade to a position off of said surface.

75. The method of claim 69, further comprising providing means for collecting dust generated while cutting said material.

76. The method of claim 69, further comprising cutting said material from a lateral side of said material.

77. A method of cutting a material, said method comprising:
placing said material on a surface between a user and a blade;
positioning said material against an abutment, said abutment having a gap;
moving said blade through said gap toward said user.

78. The method of claim 77, further comprising moving said blade through a slot in said surface.

79. The method of claim 77, further comprising measuring said material using measuring indicia on said abutment.

80. The method of claim 77, further comprising placing a spacer between said material and said abutment.

81. The method of claim 77, further comprising biasing said blade to a position off of said surface.

82. The method of claim 77, further comprising providing means for collecting dust generated while cutting said material.

83. The method of claim 77, further comprising cutting said material from a lateral side of said material.
